(19) United States
(12) Patent Application Publication
(10) Pub. No.: US 2024/0197142 A1
(43) Pub. Date: Jun. 20, 2024

(54) A SENSOR ASSEMBLY FOR SENSING THE TURBIDITY OF A CLEANING MEDIUM IN A CLEANING APPLIANCE

(71) Applicant: ILLINOIS TOOL WORKS INC., GLENVIEW, IL (US)

(72) Inventors: Davide BORDIGNON, Varese (IT); Rocco CORBISIERO, Varese (IT); Massimo PERUZZO, Varese (IT)

(73) Assignee: ILLINOIS TOOL WORKS INC., GLENVIEW, IL (US)

(21) Appl. No.: 18/286,328

(22) PCT Filed: Apr. 1, 2022
(86) PCT No.: PCT/US2022/023117

§ 371 Date: Oct. 10, 2023

(30) Foreign Application Priority Data
Apr. 12, 2021 (EP) 211679226.1

(51) Int. Cl. A47L 15/42; G01N 21/85

(52) U.S. Cl. CPC A47L 15/4297; G01N 21/8507; G01N 2021/8528

(57) ABSTRACT

The present disclosure relates to a sensor assembly (100) for sensing the turbidity of a cleaning medium in a cleaning appliance (190), comprising: a printed circuit board (122) having a substantially planar top surface and a substantially planar bottom surface; a light emitter (112) operably mounted to said printed circuit board (122), configured to emit an electromagnetic signal in a first direction substantially perpendicular to and away from said planar top surface; a light receiver (114) operably mounted to said printed circuit board (122) spaced apart from said light emitter (112) along said substantially planar top surface, configured to receive said electromagnetic signal from a second direction substantially perpendicular to and towards said planar top surface of said printed circuit board (122); and a light guide (150), operably coupleable between said light emitter (112) and said light receiver (114), defining a signal path (116) extending from said light emitter (112) to said light receiver (114) utilising: a first light guide portion (152), configured to reflectingly redirect said electromagnetic signal in a third direction non-parallel to said first direction and in a fourth direction non-parallel to said third direction at a first light guide exit point (160), and a second light guide portion (162), spaced apart from said first light guide portion (152) in a direction parallel to said planar top surface by a predetermined gap, configured to receive said electromagnetic signal exiting said first light guide exit point (160) and reflectingly redirect said electromagnetic signal in a fifth direction non-parallel to said fourth direction and in a sixth direction coaxial with said second direction.

### BACKGROUND OF THE INVENTION

### Field of the Invention

The present invention relates to a sensor assembly, in particular, but not exclusively, to a sensor assembly for sensing the turbidity of a cleaning medium in a cleaning appliance. Even more particularly, the present invention relates to a sensor assembly including a light emitter, light receiver and a light guide, the sensor assembly suitable for sensing the turbidity of a cleaning medium in a cleaning appliance, such as a washing machine or dishwasher.

### Discussion of Related Art

Cleaning appliances, such as dishwashers and washing machines, are flushed using a cleaning medium such as washing water to wash laundry or dishes. The efficiency of these cleaning appliances is affected, inter alia, by the turbidity, also referred to as the ‘dirtying’ or ‘dirtiness’, of the cleaning medium (cleaning fluid). In order to measure the fluid turbidity, existing cleaning appliances use optical sensors whereby a section of a light path passes through a washing chamber containing the cleaning medium (e.g., washing water). When passing through the cleaning medium, the light undergoes attenuation due to the cloudiness of the cleaning medium. The extent of attenuation is measured, for example, by a photosensor receiving the attenuated light beam to then determine its turbidity and control the appliance accordingly.

Typically, optical sensors used to determine the turbidity of the cleaning medium is relatively large in size, having an optical emitter arranged on one side of the washing chamber, and an optical receiver arranged on the other side of the washing chamber, along with the associated electronic circuitry. However, these sensors are often positioned away from an area where soil deposition occurs, for example at the bottom of a sump, so that turbidity measurements are not distorted by soil deposition. As a result, a relatively large area is required within the cleaning appliance to accommodate the sensor or sensor assembly. Also, due to the size of the arrangement, the turbidity measured by the sensor can often be distorted in comparison to the actual turbidity of the cleaning medium. In addition, the arrangement of such known turbidity sensors may be subject to unwanted signals transmitted between sensors as a result of coupling from one circuit or channel to another, which is also known as ‘crosstalk’. A further problem with existing sensor assemblies is that electronic components, such as circuitry or sensors, are placed too close to areas of the cleaning appliance where cleaning medium is present and are therefore susceptible to damage in the event of water leakage from the cleaning appliance.

FIG. 1 shows a known sensor assembly 1 for a household appliance described in document U.S. Pat. No. 6,771,373 B2, having a housing 2 with a first housing finger 8 and a second housing finger 10 each extending away from a base of the housing 2. The first housing finger 8 accommodates a first optical element 12 while the second housing finger 10 accommodates a second optical element 14. The optical elements 12,14 are connected to a circuit board 22 and arranged facing one another such that a sensing beam 16 propagates from the first optical element 12, through a window 34 on the first finger 8, through a gap between the fingers 8,10, through a window 36 on the second finger 10, and towards the second optical element 14. When a cleaning medium is positioned in the gap between the fingers 8,10, the turbidity of the cleaning medium is determined by measuring the attenuation of the light signal between the first optical element 12 and the second optical element 14. The second finger 10 not only accommodates the second optical element 14, but also accommodates a temperature sensor 20.

This arrangement requires optical elements which are arranged within fingers 8,10 protruding away from the main body of the sensor assembly 1 and therefore requires a large area in the cleaning appliance to accommodate this arrangement. Moreover, the arrangement of a temperature sensor 20 is in close proximity with one of the optical elements 14, which may lead to a signal quality distortion, potentially affecting the accuracy of sensor measurements within the assembly 1. In addition, the presence of cleaning medium between the fingers 8,10 presents a risk of damage to the sensors and electronics in the event of water leakage.

FIG. 2 shows another known sensor assembly 41 for a household appliance described in U.S. Pat. No. 8,648,321 B2, which is mounted in an aperture of a wall 90. The sensor assembly 41 has a housing 42 with a central axis 44, and first and second projecting protuberances 48,50. A circuit board 62 is provided which accommodates a light-emitting diode 52 serving as a light-emitting element, and a photodiode 54 serving as a light-receiving element. The sensor assembly 41 has a light-conducting body 70 with a first light-conducting finger 72 and a second light-conducting finger 82, projecting into respective protuberances 48,50. The second protuberance 50 accommodates a temperature sensor 60. The free end of the first light-conducting finger 72 has a first reflection surface 76 and the free end of the second light-conducting finger 82 has a second reflection surface 78.

Light is emitted along a light path 56 from the emitting diode 52 through a collecting lens 64 into the first light-conducting finger 72 of the light-conducting body 70. The light reflects from the first reflection surface 76 through the wall of the first protuberance 48, along a path portion 58 and through the wall of the second protuberance 50, into the second light-conducting finger 82. There, the light reflects off the second reflection surface 78 and through the second light-conducting finger 82, towards a collecting lens 66 and is directed onto the photodiode 54. When a cleaning medium is positioned between the protuberances 48,50, the turbidity of the cleaning medium is determined by measuring the attenuation of light between the emitting diode 52 and the photodiode 54. Since the light-conducting body 70 is positioned within the housing 42 of the sensor assembly 41, a large area is required within the cleaning appliance to accommodate the assembly 41. Moreover, the light-conducting body 70 is required within the housing 42 to shield other sensors from unwanted signals from the diodes 52,54 which would otherwise distort the signal quality and therefore also affect the accuracy of sensor measurements. In addition, both the light-emitting diode 52 and the photodiode 54 are mounted onto the circuit board 62 and bend forward by 90 degrees in order to direct and receive the light into and from respective lenses 64, 66. Such an arrangement is relatively space-consuming, as well as, prone to allow crosstalk between the two diodes 52 and 54.

Consequently, it would be desirable to provide a sensor assembly that can alleviate or mitigate one or more of the aforementioned problems. Particularly, it is an object of the invention to provide a sensor assembly that reduces unwanted signal communication between components, circuits and channels without requiring additional shielding components. It is another object of the invention to provide a sensor assembly, that is more compact in comparison to existing sensor assemblies of the prior art. It is a further object of the present invention to reduce or mitigate risk of water damage to the sensors and electronic components.

The present invention provides at least an alternative to sensor assemblies of the prior art.

### SUMMARY OF THE INVENTION

In accordance with the present invention there is provided a sensor assembly according to the appended claims.

According to an aspect of the present invention, there is provided a sensor assembly for sensing the turbidity of a cleaning medium in a cleaning appliance, comprising:
a printed circuit board having a substantially planar top surface and a substantially planar bottom surface;
a light emitter operably mounted to said printed circuit board, configured to emit an electromagnetic signal in a first direction substantially perpendicular to and away from said planar top surface;
a light receiver operably mounted to said printed circuit board spaced apart from said light emitter along said substantially planar top surface, configured to receive said electromagnetic signal from a second direction substantially perpendicular to and towards said planar top surface of said printed circuit board; and
a light guide, operably coupleable between said light emitter and said light receiver, defining a signal path extending from said light emitter to said light receiver utilising: a first light guide portion, configured to reflectingly redirect said electromagnetic signal in a third direction non-parallel to said first direction and in a fourth direction non-parallel to said third direction at a first light guide exit point, and a second light guide portion, spaced apart from said first light guide portion in a direction parallel to said planar top surface by a predetermined gap, configured to receive said electromagnetic signal exiting said first light guide exit point and reflectingly redirect said electromagnetic signal in a fifth direction non-parallel to said fourth direction and in a sixth direction coaxial with said second direction.

Thus, the sensor assembly reduces crosstalk between components, circuits and channels without requiring additional shielding components. In particular, arrangement of the sensor assembly reduces crosstalk between the light emitter and light receiver. By providing the sensor assembly with the defined signal path, there is increased spatial freedom to apply the assembly to a wider range of cleaning appliances, and the sensor assembly is made more compact. In addition, the light emitter and the light receiver are positioned away from the location of the cleaning medium, which reduces risk of water damage to the electronic components.

Advantageously, in some embodiments, each one of said third, fourth and fifth direction may be perpendicular to a respective previous direction of said electromagnetic signal.

Advantageously, in some embodiments, said fourth direction across said predetermined gap may be substantially parallel to said planar top surface.

Advantageously, in some embodiments, said first light guide exit point may be spaced apart from said light emitter in a direction parallel to said planar top surface of said printed circuit board.

Advantageously, in some embodiments, an interface between said light emitter and a first light guide entry point of said first light guide portion may be a collimating lens configured to collimatingly couple said electromagnetic signal from said light emitter into said first light guide portion.

Advantageously, in some embodiments, an interface between said light receiver and a second light guide exit point of said second light guide portion may be a collimating lens configured to focus said electromagnetic signal from said second light guide portion into said light receiver.

Advantageously, in some embodiments, each one of said light emitter and said light receiver may be operably received within an aperture of said printed surface board from said planar bottom surface towards said planar top surface.

Advantageously, in some embodiments, each one of said light emitter and said light receiver may be fully embedded within said aperture.

Advantageously, in some embodiments, said light emitter may be a Light-Emitting-Diode (LED) and said light receiver may be any one of a photodiode and a photoresistor.

### BRIEF DESCRIPTION OF SEVERAL VIEWS OF THE DRAWINGS

Embodiments of the invention are now described, by way of example only, hereinafter with reference to the accompanying drawings, in which:

FIG. 1 (Prior Art) is a schematic representation of a known sensor assembly 1 of the prior art;

FIG. 2 (Prior Art) is a schematic representation of another known sensor assembly 41 of the prior art;

FIG. 3A illustrates a sensor assembly 100 in a perspective view;

FIG. 3B illustrates a sensor assembly 100 in a schematic side elevation view;

FIG. 4A illustrates the sensor assembly 100 of FIGS. 3A-B, mounted onto an appliance 190, in a bottom perspective view;

FIG. 4B illustrates a sensor assembly 100 of FIGS. 3A-B, mounted onto an appliance 190, in a side perspective view;

FIG. 4C illustrates a sensor assembly 100 of FIGS. 3A-B, mounted onto an appliance 190, in a front elevation view; and

FIG. 5 illustrates an exploded perspective view of the sensor assembly 100 of FIGS. 3A-B.

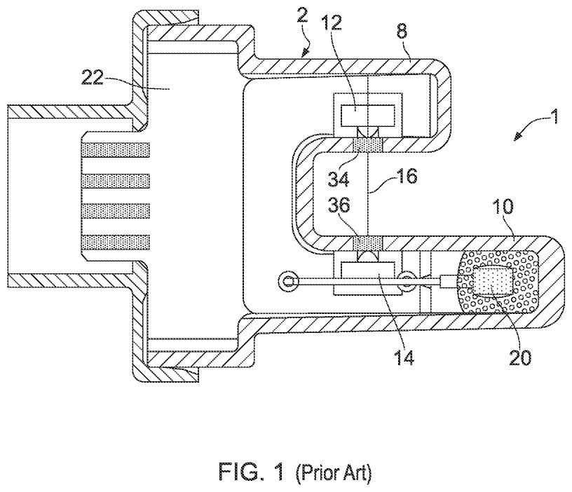

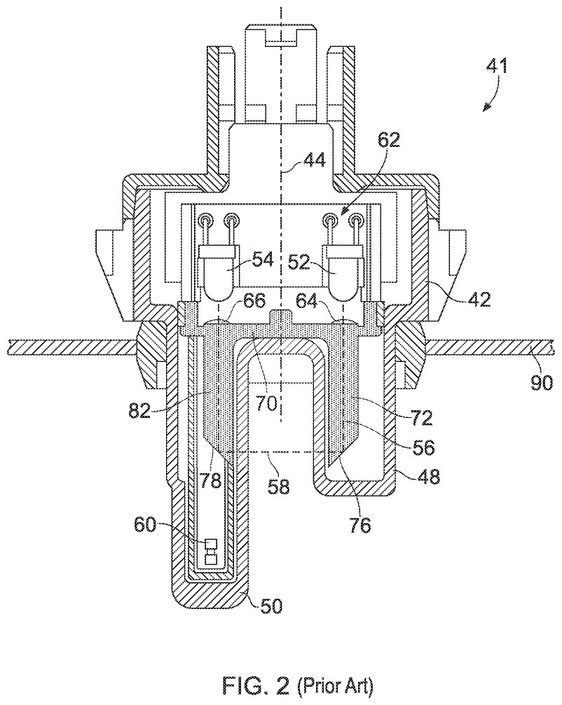

### DETAILED DESCRIPTION OF THE INVENTION

The described example embodiment relates to a sensor assembly for mounting to a cleaning appliance and particularly to a sensor assembly for mounting to a dishwasher or a washing machine. However, the invention is not necessarily restricted to a sensor assembly for mounting to a dishwasher or a washing machine, but may also be used for mounting to another appliance for measuring the turbidity of a cleaning medium.

Certain terminology is used in the following description for convenience only and is not limiting. The words ‘right’, ‘left’, ‘lower’, ‘upper’, ‘front’, ‘rear’, ‘upward’, ‘down’ and ‘downward’ designate directions in the drawings to which reference is made and are with respect to the described component when assembled and mounted. The words ‘inner’, ‘inwardly’ and ‘outer’, ‘outwardly’ refer to directions toward and away from, respectively, a designated centreline or a geometric centre of an element being described (e.g., central axis), the particular meaning being readily apparent from the context of the description.

Further, as used herein, the terms ‘connected’, ‘attached’, ‘coupled’, ‘mounted’ are intended to include direct connections between two members without any other members interposed therebetween, as well as indirect connections between members in which one or more other members are interposed therebetween. The terminology includes the words specifically mentioned above, derivatives thereof, and words of similar import.

Further, unless otherwise specified, the use of ordinal adjectives, such as, “first”, “second”, “third” etc. merely indicate that different instances of like objects are being referred to and are not intended to imply that the objects so described must be in a given sequence, either temporally, spatially, in ranking or in any other manner.

Like reference numerals are used to depict like features throughout.

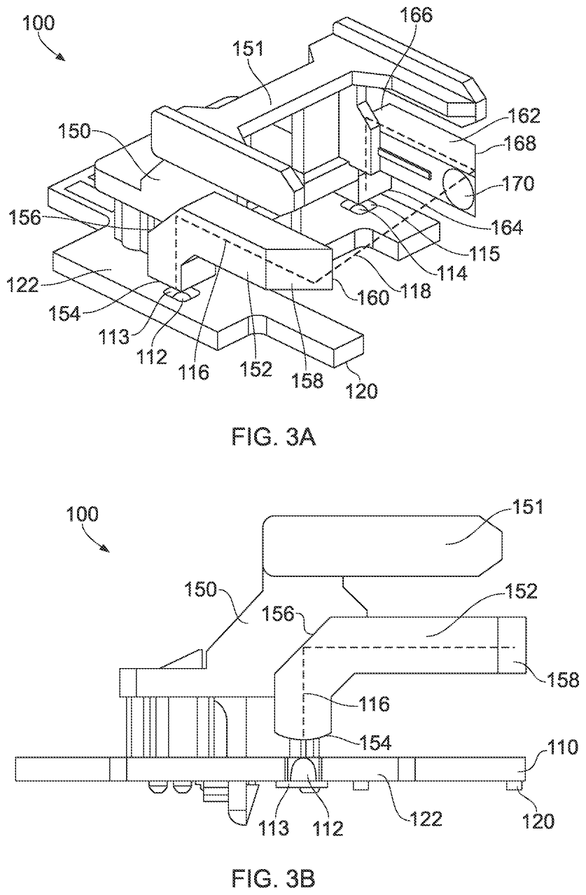

FIG. 3A and FIG. 3B show a sensor assembly 100. The sensor assembly 100 includes a printed circuit board 122 with a substantially planar top surface and a substantially planar bottom surface. A light emitter 112, in the form of a diode, is mounted through an aperture 113, to the printed circuit board 122. A light receiver 114, in the form of a photodiode, is mounted through an aperture 115, to the printed circuit board 122, spaced apart from the light emitter 112 along the surface of the circuit board 122. In some example embodiments, the light receiver 114 is a photoresistor. The light emitter 112 and the light receiver 114 are set into the printed circuit board 122 from the back such that only the front of the light emitter 112 and the light receiver 114 protrude from the circuit board 122. That is, the rest of the light emitter 112 and the light receiver 114 are hidden (i.e., blocked) by the printed circuit board 122, which reduces unwanted communication between components, circuits and channels without requiring additional shielding components. In this example embodiment, the light emitter 112 is configured to emit light away from the circuit board 122 in a direction perpendicular to the planar surface. The light receiver 114 is configured to receive light from a direction perpendicular to the planar surface of the circuit board 122. Although the light emitter 112 and the light receiver 114 are configured to emit and receive light in this example embodiment, it is envisaged that the light emitter 112 and light receiver 114 may be configured to emit and receive, respectively, a different type of electromagnetic signal.

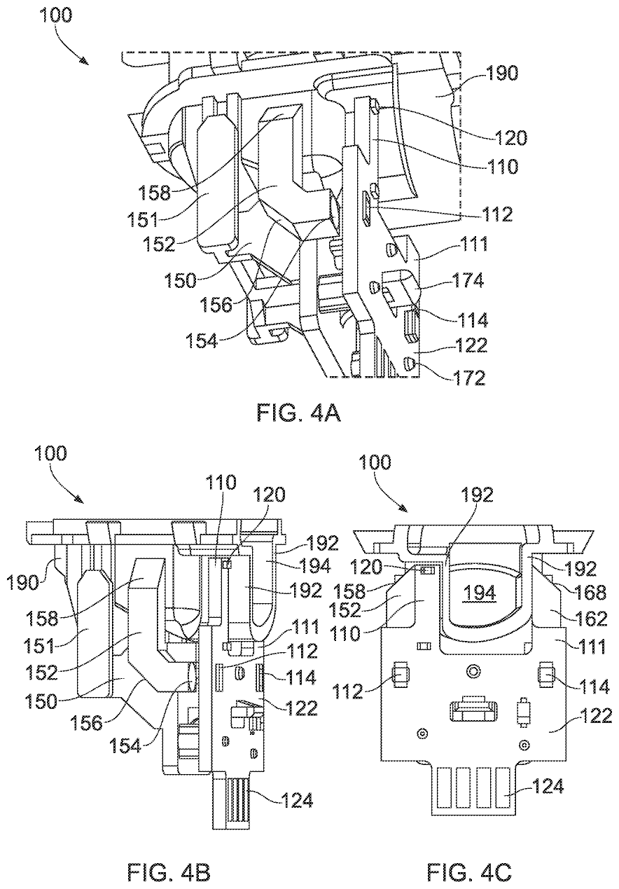

The sensor assembly 100 includes a light guide 150, which in this example embodiment is coupled with the circuit board 122. The light guide 150 is formed from a transparent material that is light-conductive. In this example embodiment, the light guide 150 is formed from polycarbonate. However, other materials are envisaged such as acrylic, polyethylene terephthalate, polyvinyl chloride or polyester, for example. In some example embodiments, the light guide 150 is formed from a translucent material. The light guide 150 is fixed to a coupling bracket 151 to mount the sensor assembly 100 to a cleaning appliance (190, FIGS. 4A-B).

The light guide 150 defines a signal path 116 extending between the light emitter 112 and the light receiver 114. The light guide 150 has a first guide 152 positioned on one lateral side relative to the circuit board 122, and a second guide 162 positioned on the other lateral side relative to the circuit board 122 such that the second guide 162 is spaced apart from the first guide 152 by a gap. The first guide 152 and the second guide 162 form portions of the light guide 150. The first guide 152 has an entry surface 154 and the second guide 162 has an exit surface 164. The entry surface 154 and the exit surface 164 are positioned on a plane parallel to the surface of the printed circuit board 122. The first guide 152 and the second guide 162 are reflectively symmetrical with one another about a plane perpendicular to the surface of the circuit board 122. The first guide 152 includes the entry surface 154 arranged facing the printed circuit board 122 and the second guide 162 includes the exit surface 164 arranged facing the printed circuit board 122. On one side of the gap, the first guide 152 is provided with an intermediate exit surface 160. On the other side of the gap, the second guide 162 is provided with an intermediate entry surface 170. In this example embodiment, the intermediate exit surface 160 and the intermediate entry surface face one another and are each arranged perpendicular to surface of the circuit board 122.

The light emitter 112 is arranged in a location oppositely facing the entry surface 154 of the first guide 152. The light receiver 114 is arranged in a location oppositely facing the exit surface 164 of the second guide 162. The first guide 152 has an entry surface 154 oppositely facing the circuit board 122, and a first reflecting surface 156 on a side of the entry surface 154 away from the circuit board 122. In this example embodiment, the entry surface 154 and the first reflecting surface 156 form an angle of 45 degrees. However, other angles are envisaged, such as, but not limited to, 30 degrees, 35 degrees, 40 degrees, 50 degrees, 55 degrees, and 60 degrees, for example. The first guide 152 has a second reflecting surface 158 positioned away from the first reflecting surface 156. The first reflecting surface 156 and the second reflecting surface 158 are arranged such that their surfaces are perpendicular to one another.

Referring now to FIG. 4A, FIG. 4B and FIG. 4C, the light guide 150 and printed circuit board 122 are mounted together through the engagement of projecting pins 172 and a clip 174, with respective apertures and an opening in the circuit board 122. The sensor assembly 100 is further mounted to the cleaning appliance 190 through engagement of the coupling bracket 151. As used herein, the term “proximal” is used to describe a side of the sensor assembly 100 which is near the cleaning appliance 190, and the term “distal” is used to describe a side of the sensor assembly 100 which is positioned away from the cleaning appliance 190.

The proximal side of the circuit board 122 is provided with a first protuberance 110 on a lateral side and a second protuberance 111 on the other lateral side. The first protuberance 110 protrudes a greater distance than the second protuberance 111 such that the end of the first protuberance 110 is closer to the cleaning appliance 190 in comparison with the second protuberance 111. The distal side of the circuit board 122 is provided with a plug connector 124, to which a control unit (not shown) may be connected, to communicate with the circuit board 122. In this example embodiment, a temperature sensor 120 is mounted at the proximal end of the first protuberance 110, spaced apart from the light emitter 112 and the light receiver 114 in a direction parallel to the surface of the circuit board 122 in the proximal direction.

Referring to FIG. 4C, the second guide 162 is reflectively symmetrical to the first guide 152. The sensor assembly 100 is mounted onto the cleaning appliance 190. More specifically, the cleaning appliance 190 is provided with a sump (i.e. chamber) 194 acting as a reservoir for collecting the cleaning medium, having outer walls 192. In this example embodiment, the walls 192 are transparent. However, in other example embodiments, the walls 192 are provided with windows through which the light signal can pass. The first guide 152 and the second guide 162 are arranged flush against the outside of the walls 192. In this example embodiment, the first protuberance 110 is arranged next to the outer wall 192 such that the temperature sensor 120 is arranged in close proximity with the sump 194, away from a bottom area of the sump 194. This reduces temperature measurements distortion caused by depositions, such as additives or dirt, at the bottom of the sump 194.

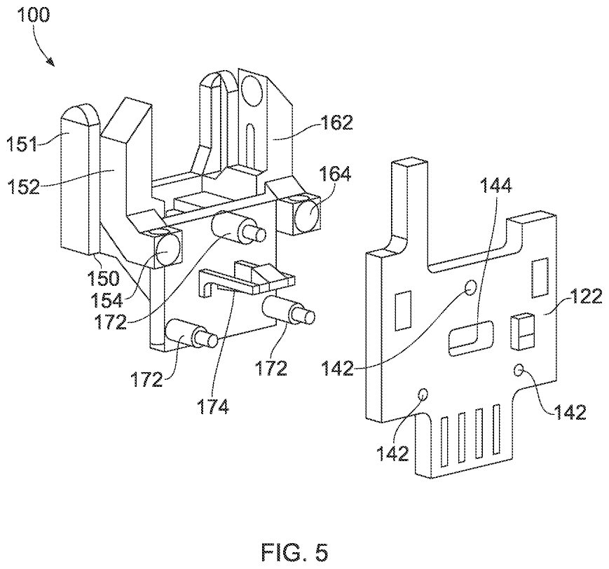

FIG. 5 shows the sensor assembly 100 in an exploded view. In this example embodiment, the printed circuit board 122 has three apertures 142 arranged spaced apart from one another and extending through the surface from one side to the other. The apertures 142 are arranged to form three corners of an equilateral triangle. A rectangular opening 144 extends through the surface of the printed circuit board 122 from one side to the other, and is positioned in the centre of the apertures 142. It is envisaged that a different number of apertures 142 and/or openings 144, may be arranged on the printed circuit board 122, and having a different spatial arrangement.

A plurality of axially projecting pins 172 protrude from a surface of the light guide 150 in a position corresponding to the apertures 142 of the printed circuit board 122, such that the projecting pins 172 are directed towards the apertures 142. A clip 174 also protrudes from the surface of the light guide 150, positioned at the centre of the projecting pins 172, such that it is directed towards the opening 144 of the printed circuit board. In some example embodiments, the printed circuit board 122 has an opening 144 and no apertures 142, and the light guide 150 has a clip 174 and no projecting pins 172. In some example embodiments, the printed circuit board 122 has apertures 142 and no opening 144, and the light guide 150 has projecting pins 172 and no clip 174. In some example embodiments, the printed circuit board 122 and the light guide 150 of the sensor assembly 100 does not include any apertures 142, opening 144, projecting pins 172 or a clip 174, as these features are optional.

As best shown in FIG. 3A, in use, the light emitter 112 emits a light signal (e.g., light ray) 116 away from the surface of the circuit board 122. The light signal 116, in this example embodiment, is directed away from the circuit board 122 in a direction substantially perpendicular to the surface of the circuit board 122. Since the light signal 116 is directed away from the surface of the circuit board 122, crosstalk between the light emitter 112 and the light receiver 114 is reduced. Crosstalk is further reduced by arranging the light emitter 112 and the light receiver 114 in the respective apertures 113,115 of the printed circuit board 122 such that they are shielded, and protrude only from the front of the circuit board 122. The light signal 116 enters the entry surface 154 of the first guide 152. In some example embodiments, the entry surface 154 has a convex shape to adjust the light signal 116 into parallel light beams. In other examples, a collimator lens is provided in an interface between the light emitter 112 and the entry surface 154 of the first guide 152 to adjust the light signal 116 into parallel light beams. Once the light signal 116 enters into the first guide 152, it travels through the first guide 152 and reflects off the first reflecting surface 156, to be directed through the first guide 152 towards the second reflecting surface 158. The light signal 116 reflects off the second reflecting surface 158, to direct the light signal 116 towards an intermediate exit surface 160. In this example embodiment, the light signal 116 directed towards a reflecting surface and the perpendicular to the light signal 116 reflecting away from the reflecting surface. However, it is envisaged that the light signal 116 reflected away from any of the reflecting surfaces may be redirected to be any non-parallel orientation relative to the light signal directed towards the reflecting surface, such as for example, 15 degrees, 30 degrees, 45 degrees, 60 degrees, or 75 degrees, for example.

Once the light signal 116 exits the first guide 152 from an intermediate exit surface 160 (i.e., exit point), it is transmitted towards an intermediate entry surface 170 (i.e., entry point) of the second guide 162. In this particular example, the light signal 116 transmitted in the gap between the intermediate exit surface 160 and the intermediate entry surface 170 is directed in a plane parallel to the surface of the circuit board 122. At the intermediate entry surface 170 of the second guide 162, the light signal 116 enters into the second guide 162 and reflects off the third reflecting surface 168, where it travels through the second guide 162 and reflects off the fourth reflecting surface 166, through the exit surface 164, to be received by the light receiver 114 in a direction substantially perpendicular to the surface of the circuit board 122. In this example embodiment, the exit surface 164 and the fourth reflecting surface 166 form an angle of 45 degrees. However, other angles are envisaged, such as 30 degrees, 35 degrees, 40 degrees, 50 degrees, 55 degrees, and 60 degrees, for example. In some example embodiments, the exit surface 164 has a convex shape to focus the light signal 116 into the light receiver 114. In other examples, a collimator lens is provided in an interface between the exit surface 164 and the light receiver 114 to focus the light signal 116 into the light receiver 114.

When the sensor assembly 100 is mounted to a cleaning appliance 190 in an arrangement shown in FIGS. 4A-B, the light signal 116 exits the intermediate exit surface 160 of the first guide 152 and is transmitted towards the intermediate entry surface 170 of the second guide 162. A portion of the light signal 116 path, denoted 118 is outside of the light guide 150 and runs through the walls 192 of the cleaning appliance 190, and into the sump 194 in which the cleaning medium is collected. As the light signal 116 passes through the cleaning medium in the sump 194, the light signal 116 is attenuated. The sensor assembly 100 measures the attenuation of the light signal 116 between the light emitter 112 and the light receiver 114 to determine the turbidity of the cleaning medium in the sump 194. The light emitter 112, the light receiver 114, the temperature sensor 120 and the printed circuit board 122 are positioned away from the sump 194 such that risk of water damage to these components is reduced.

Alternative embodiments are also envisaged. For example, a different number of reflecting surfaces may be provided in the light guide 150. In one example embodiment, a plurality of reflecting surfaces, such as three reflecting surfaces, are provided in the first guide 152. A plurality of reflecting surfaces, such as three reflecting surfaces, are also provided in the second guide before the exit surface 164. The reflecting surfaces are arranged in the light guide 150 so that a light signal 116 is reflectively directed through the plurality of reflecting surfaces in the first guide 152, through the gap between the first guide 152 and the second guide 162, and reflectively directed through the plurality of reflecting surfaces in the second guide 162. Thus, a light signal 116 emitted by the light emitter 112 enters the entry surface 154, travels towards and is reflected by the plurality of reflecting surfaces in the first guide 152, out of an intermediate exit surface 160 and through a sump 194 containing the cleaning medium. The light signal 116 then enters into the intermediate entry surface 170 and reflects off the plurality of reflecting surfaces in the second guide 162, and is directed through the exit surface 164 to be received by the light receiver 114.

In another example embodiment, the first guide 152 and the second guide 162 of the light guide 150 are formed as a single component, having an entry surface 154 oppositely facing the light emitter 112, exit surface 164 oppositely facing the light receiver 114, and having a plurality of reflection surfaces for directing a light signal 116 from the light emitter 112, through the entry surface 154, through various reflection surfaces, to the exit surface 164 and to the light receiver 11.

Through the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract or drawings), or to any novel one, or any novel combination, of the steps of any method or process so disclosed.

It will be appreciated by persons skilled in the art that the above embodiment(s) have been described by way of example only and not in any limitative sense, and that various alterations and modifications are possible without departing from the scope of the invention as defined by the appended claims. Various modifications to the detailed designs as described above are possible.

1. A sensor assembly for sensing the turbidity of a cleaning medium in a cleaning appliance, comprising:
a printed circuit board having a substantially planar top surface and a substantially planar bottom surface;
a light emitter, operably mounted to the printed circuit board, configured to emit an electromagnetic signal in a first direction substantially perpendicular to and away from the planar top surface;
a light receiver, operably mounted to the printed circuit board spaced apart from the light emitter along the substantially planar top surface, configured to receive the electromagnetic signal from a second direction substantially perpendicular to and towards the planar top surface of the printed circuit board; and
a light guide, operably coupleable between the light emitter and the light receiver, defining a signal path extending from the light emitter to the light receiver utilizing:
first light guide portion, configured to reflectingly redirect the electromagnetic signal in a third direction non-parallel to the first direction, and in a fourth direction non-parallel to the third direction at a first light guide exit point, and
a second light guide portion, spaced apart from the first light guide portion in a direction parallel to the planar top surface by a predetermined gap, configured to receive the electromagnetic signal exiting the first light guide exit point and reflectingly redirect the electromagnetic signal in a fifth direction non-parallel to the fourth direction and in a sixth direction coaxial with the second direction.

2. A sensor assembly according to claim 1, wherein
each one of the third, fourth and fifth direction is perpendicular to a respective previous direction of the electromagnetic signal.

3. A sensor assembly according to claim 1, wherein the fourth direction across the predetermined gap is substantially parallel to the planar top surface.

4. A sensor assembly according to claim 1, wherein the first light guide exit point is spaced apart from the light emitter in a direction parallel to the planar top surface of the printed circuit board.

5. A sensor assembly according to claim 1, wherein an interface between the light emitter and a first light guide entry point of the first light guide portion is a collimating lens configured to collimatingly couple the electromagnetic signal from the light emitter into the first light guide portion.

6. A sensor assembly according to claim 1, wherein an interface between the light receiver and a second light guide exit point of the second light guide portion is a collimating lens configured to focus the electromagnetic signal from the second light guide portion into the light receiver.

7. A sensor assembly according to claim 1, wherein each one of the light emitter and the light receiver is operably received within an aperture of the printed surface board from the planar bottom surface towards the planar top surface.

8. A sensor assembly according to claim 7, wherein each one of the light emitter and the light receiver is fully embedded within the aperture.

9. A sensor assembly according to claim 8, wherein the light emitter is a Light-Emitting-Diode (LED) and the light receiver is any one of a photodiode and a photoresistor.
